(19) United States
(12) Patent Application Publication
(10) Pub. No.: US 2025/0134104 A1
(43) Pub. Date: May 1, 2025

(54) AGROCHEMICAL ADJUVANTS

(71) Applicant: Croda International Plc, Goole, East Yorkshire (GB)

(72) Inventors: Gregory James Lindner, Plainsboro, NJ (US); Bradley Arnold Haltli, Charlottetown, Prince Edward Island (CA); Russell Greig Kerr, Charlottetown, Prince Edward Island (CA); Alyssa Louise Grunwald, Charlottetown, Prince Edward Island (CA); Hebelin Correa Velandia, Charlottetown, Prince Edward Island (CA); Douglas Hubert Marchbank, Charlottetown, Prince Edward Island (CA)

(73) Assignee: Croda International Plc, Goole, East Yorkshire (GB)

(21) Appl. No.: 18/837,133

(22) PCT Filed: Feb. 9, 2023
(86) PCT No.: PCT/IB2023/000148

§ 371 Date: Aug. 8, 2024

Related U.S. Application Data
(60) Provisional application No. 63/309,869, filed on Feb. 14, 2022.

(51) Int. Cl. A01N 43/90; A01N 43/60; A01P 3/00

(52) U.S. Cl. CPC A01N 43/90; A01N 43/60; A01P 3/00

(57) ABSTRACT

An agrochemical formulation comprising adjuvants selected from diketopiperazines and an agrochemical active. A concentrate is also provided suitable for forming the formulation. The diketopiperazines provide adjuvancy in the concentrate and agrochemical formulations. There is also provided a method of making the formulation, and use of said diketopiperazines as adjuvants in agrochemical formulations is also provided. A method of forming the diketopiperazines is also described. The diketopiperazines may be used in a formulation for treating vegetation to control pests, or in a seed coating.

The invention relates generally to adjuvants for agrochemical active formulations, and a method of providing adjuvancy in agrochemical formulations comprising said adjuvants with one or more agrochemical actives. The present invention also includes treating crops with said formulations.

An adjuvant is generally defined as a chemical or a mixture of chemicals capable of improving the biological activity or effectiveness of an agrochemical active. Adjuvants do not themselves control or kill pests. Instead, these additives may interact with molecular targets (e.g., cell wall, ion channels, structural proteins, enzymes, etc.) within the target organism, or modify some property (e.g., spreading, retention, penetration, droplet size) of the agrochemical formulation, thereby improving the biological activity of the agrochemical active on the organism. The typical types of compounds used as adjuvants may include small molecules, surfactants, emulsifiers, oils, and salts. Adjuvants do not typically inhibit translocation of the active in the treated plant. In addition, the adjuvant should not produce unwanted phytotoxic effects on the plant.

Fungi are widespread in terrestrial environments and present a major challenge to agricultural productivity. Unchecked fungal infections can result in pre- and post-harvest crop losses that can exceed 80%. In order to help reduce such loses and meet increasing food needs, the use of fungicides to control fungal agricultural pests is, and will continue to be, an important component of agricultural pest management systems.

There is a need to develop new strategies to combat agricultural pests, especially fungal pests. One strategy is to develop adjuvants that are safe, non-toxic chemicals which improve the effectiveness of existing fungicides already approved for use on field and greenhouse crops to prevent or reduce the impact of fungal pests on agricultural productivity. These adjuvants can improve the control of pests in the field or after harvest, thereby increasing productivity. They may also reduce the quantities of fungicide required to achieve the desired level of pest control, thus contributing to the goal of achieving sustainable productivity increases.

The present invention seeks to provide the use of compounds in agrochemical formulations in combination with an agrochemical active, where the compounds may provide desired adjuvancy, including improved efficacy of the active. The present invention also seeks to provide the use of agrochemical concentrates, dilute formulations, and seed coatings comprising said adjuvants.

The present invention also seeks to provide compounds in agrochemical formulations, where the compound may provide comparable or improved adjuvancy properties compared to existing adjuvants.

The present invention also seeks to provide the use of compounds as adjuvants, and formulations comprising said compounds for use in providing adjuvancy in agrochemical formulations.

According to a first aspect of the present invention there is provided an agrochemical formulation comprising;
i) an adjuvant selected from diketopiperazine according to formula (I)

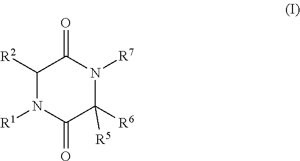

wherein:

R¹ represents hydrogen or C₁ to C₄ alkyl;

R² represents hydrogen, C₁ to C₄ alkyl, or —CH(R³) (R⁴);

R³ and R⁴ each independently represents hydrogen, C₁ to C₃ alkyl, phenyl, or substituted phenyl;

R⁵ represents hydrogen, C₁ to C₄ alkyl, hydroxyl, methoxy, or ethoxy;

R⁶ and R⁷ each independently represents hydrogen, C₁ to C₄ alkyl, hydroxyl, methoxy, ethoxy, or R⁶ and R⁷ together represent a straight chain C₃ or C₄ linking group, which with the respectively bonded N and C atoms forms a 5 or 6 membered optionally substituted saturated or unsaturated ring; and
ii) at least one agrochemical active, nutrient, or biostimulant.

According to a second aspect of the present invention there is provided a concentrate formulation suitable for making an agrochemical formulation of the first aspect, said concentrate comprising;
i) an adjuvant selected from diketopiperazine according to formula (I)

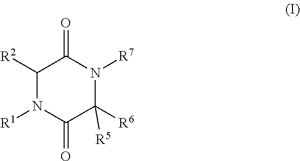

wherein:
R¹ represents hydrogen or C₁ to C₄ alkyl;
R² represents hydrogen, C₁ to C₄ alkyl, or —CH(R³) (R⁴);
R³ and R⁴ each independently represents hydrogen, C₁ to C₃ alkyl, phenyl, or substituted phenyl;
R⁵ represents hydrogen, C₁ to C₄ alkyl, hydroxyl, methoxy, or ethoxy;
R⁶ and R⁷ each independently represents hydrogen, C₁ to C₄ alkyl, hydroxyl, methoxy, ethoxy, or R⁶ and R⁷ together represent a straight chain C₃ to C₄ linking group, which with the respectively bonded N and C atoms forms a 5 or 6 membered optionally substituted saturated or unsaturated ring; and
ii) at least one agrochemical active, nutrient, or biostimulant.

According to a third aspect of the present invention there is provided the use of compound selected from diketopiperazine according to formula (I)

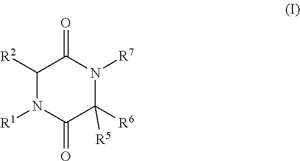

wherein:
R¹ represents hydrogen or C₁ to C₄ alkyl;
R² represents hydrogen, C₁ to C₄ alkyl, or —CH(R³) (R⁴);
R³ and R⁴ each independently represents hydrogen, C₁ to C₃ alkyl, phenyl, or substituted phenyl;
R⁵ represents hydrogen, C₁ to C₄ alkyl, hydroxyl, methoxy, or ethoxy;
R⁶ and R⁷ each independently represents hydrogen, C₁ to C₄ alkyl, hydroxyl, methoxy, ethoxy, or R⁶ and R⁷ together represent a straight chain C₃ to C₄ linking group, which with the respectively bonded N and C atoms forms a 5 or 6 membered optionally substituted saturated or unsaturated ring; as an adjuvant in an agrochemical formulation comprising at least one agrochemical active, nutrient, or biostimulant.

According to a fourth aspect of the present invention there is provided a method of treating vegetation to control pests, the method comprising applying a formulation of the first aspect, or a diluted concentrate formulation of the second aspect, either to said vegetation or to the immediate environment of said vegetation.

According to a fifth aspect of the present invention there is provided a seed coating composition comprising adjuvants according to the first aspect.

It has been found that the compounds as defined herein provide for desired adjuvancy properties when used in an agrochemical formulation having at least one agrochemical active, nutrient, or biostimulant. The diketopiperazine compounds of the class identified do not show intrinsic pesticidal activity.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

It will be understood that, when describing the number of carbon atoms in a substituent group (e.g. ‘C₁ to C₄ alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups. Diketopiperazines (DKP) are organic amide compounds with two amide linkages.

The adjuvants of the present invention are selected from diketopiperazines having a structure of formula (I);

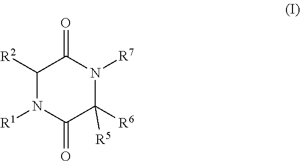

wherein:
R¹ represents hydrogen or C₁ to C₄ alkyl;
R² represents hydrogen, C₁ to C₄ alkyl, or —CH (R³) (R⁴);
R³ and R⁴ each independently represents hydrogen, C₁ to C₃ alkyl, phenyl, or substituted phenyl;
R⁵ represents hydrogen, C₁ to C₄ alkyl, hydroxyl, methoxy, or ethoxy; and
R⁶ and R⁷ each independently represents hydrogen, C₁ to C₄ alkyl, hydroxyl, methoxy, ethoxy, or R⁶ and R⁷ together represent a straight chain C₃ to C₄ linking group, which with the respectively bonded N and C atoms forms a 5 or 6 membered optionally substituted saturated or unsaturated ring.

The term ‘C₁ to C₄ alkyl’ as used herein, unless otherwise defined, refers to saturated hydrocarbon radicals being straight chain or branched, containing from 1 to 4 carbon atoms. Where any of R represent C₁ to C₄ alkyl, said alkyl may be independently selected from methyl, ethyl, n-propyl, isopropyl, n-butyl, isobutyl, sec-butyl, tert-butyl, or the like. Preferably, methyl or ethyl. More preferably, methyl.

The term ‘C₁ to C₃ alkyl’ as used herein, unless otherwise defined, refers to saturated hydrocarbon radicals being straight chain or branched, containing from 1 to 3 carbon atoms. Where any of R represent C₁ to C₃ alkyl, said alkyl may be independently selected from methyl, ethyl, n-propyl, isopropyl, or the like. Preferably, methyl or ethyl. More preferably, methyl.

The term ‘hydroxyl’ as used herein, unless otherwise stated, refers to a hydroxyl radical comprising one oxygen and one hydrogen atom having the structure —O—H, and which is bonded to an adjacent radical via the oxygen.

The terms ‘methoxy’ and ‘ethoxy’ as used herein, unless otherwise defined, refers to methyl and ethyl groups linked to oxygen which form an alkoxy radical having the structure —O—CH₃ and —O—CH₂CH₃ respectively, and which are bonded to an adjacent radical via the oxygen.

The term ‘phenyl’ as used herein, unless otherwise defined, refers to a C₆H₅ organic radical derived from a benzene aromatic hydrocarbon by removal of one hydrogen.

The term ‘substituted phenyl’ as used herein, unless otherwise defined, refers to phenyl which is substituted with methyl, ethyl, methoxy, ethoxy, or halo. Said substitution may be at any position on the aromatic ring, preferably the ortho or para positions.

The term ‘halo’ as used herein, unless otherwise defined, refers to halide radicals derived from elements in Group VII (Group 17) of the periodic table. The halide radicals may be independently selected from fluoro, chloro, bromo, or iodo. Preferably, chloro.

Preferably, R¹ represents hydrogen, methyl, or ethyl. More preferably, hydrogen or methyl.

Preferably, R² represents hydrogen or —CH (R³) (R⁴).

Where R² represents-CH (R³) (R⁴), preferably, R³ and R⁴ each independently represents hydrogen, methyl, phenyl, or substituted phenyl where the substituent is methyl, ethyl, methoxy, or ethoxy. More preferably, hydrogen or phenyl.

Preferably, at least one of R³ and R⁴ represents phenyl, whilst the other represents hydrogen, methyl, or ethyl. More preferably, one of R³ and R⁴ represents phenyl and the other represents hydrogen or methyl. Most preferably, one of R³ and R⁴ represents phenyl and the other represents hydrogen.

Preferably, R⁵ represents hydrogen or methyl. More preferably, hydrogen.

R⁶ and R⁷ independently represents hydrogen, C₁ to C₄ alkyl, hydroxyl, methoxy, or ethoxy. Preferably, hydrogen or C₁ to C₄ alkyl. More preferably, hydrogen or methyl. Further preferably, hydrogen. Particularly preferably, both R⁶ and R⁷ are hydrogen, or R⁶ is methyl and R⁷ is hydrogen.

In an alternative embodiment, R⁶ and R⁷ together form a single group and represent a straight chain C₃ to C₄ linking group. With the neighbouring N and C atoms to which R⁶ and R⁷ are bonded, this forms a 5 or 6 membered optionally substituted ring, which may be a saturated or unsaturated ring.

Said straight chain C₃ to C₄ linking group may be selected from an alkyl or alkenyl, and preferably selected from n-propyl, n-butyl, n-propenyl, or n-butenyl. Preferably, n-propyl, n-butyl, or n-propenyl.

The 5- or 6-membered rings formed in said embodiment may therefore be selected from pyrrolidine, piperidine, pyrroline, pyrrole, or pyridine. Preferably, pyrrolidine, piperidine, or pyrroline.

The 5- or 6-membered ring is optionally substituted, the term as used herein meaning that the ring may be substituted or unsubstituted. The 5- or 6-membered ring may therefore comprise one or more substituent groups on the carbon backbone, and said substituent groups may independently represent C₁ to C₄ alkyl, hydroxyl, methoxy, or ethoxy. Said substituent groups are as defined herein.

Compounds of formula (I) may have optical isomerisation around the carbon at position 2 of the pyrrolidine ring. It will be understood that both R and S isomers are included in the definitions of the diketopiperazines of formula (I). In particular, the S isomer may be preferred.

In particular, diketopiperazines selected from the following may be preferred:

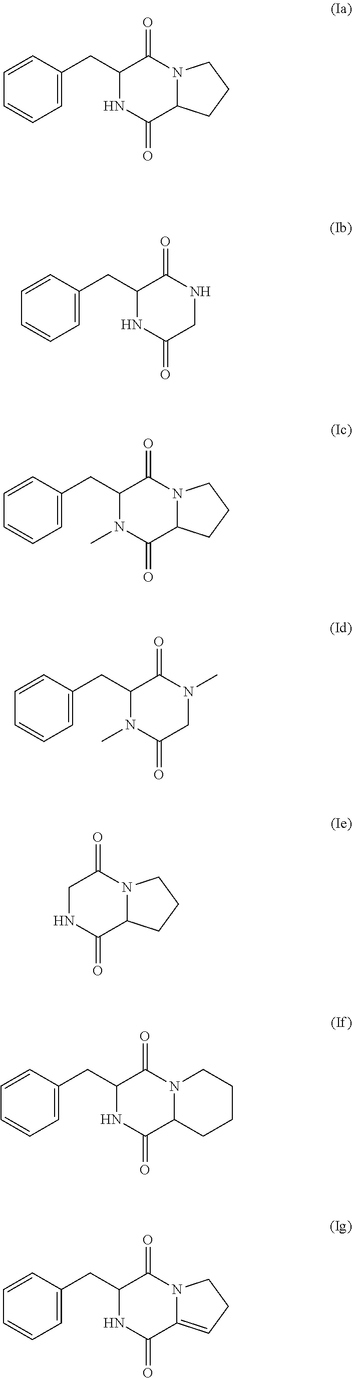

Whilst not wanting to be bound by any particular methodology, the diketopiperazines may be formed by synthetic techniques.

The diketopiperazines and its derivatives may be produced through chemical synthesis by one skilled in the art of organic chemistry using commercially available materials and synthetic methodology described in the scientific literature.

One such method is a two-step synthesis beginning with an amide coupling reaction between phenylpropiolic acid and L-prolinamide using carbodiimide-or phosphonium-based coupling reagents. A subsequent intramolecular cyclization through a nucleophilic a-addition catalysed by triphenylphosphine yields the desired diketopiperazine of formula (I). A third step can then be undertaken by methylation of the amide using iodomethane in the presence of a base where a methylated variants are desired, such as (Ic) or (Id).

The adjuvants of this invention may also be formed by microorganisms using a fermentation-based process.

The properties of the adjuvant per se will be understood to provide the same advantageous advantages for an agrochemical formulation comprising said adjuvant. Therefore, an agrochemical formulation is provided, when comprising the adjuvant of the present invention, having the advantages of the properties of the adjuvant per se.

Agrochemically active compounds, including insecticides and fungicides, require a formulation which allows the active compounds to be taken up by the plant/the target organisms.

The term ‘agrochemical formulation’ as used herein refers to compositions including an active agrochemical, and is intended to include all forms of compositions, including concentrates and spray formulations. If not specifically stated, the agrochemical formulation of the present invention may be in the form of a concentrate, a diluted concentrate, or a sprayable formulation.

The adjuvant of the present invention may be combined with other components in order to form an agrochemical formulation comprising at least one agrochemical active.

Accordingly, agrochemical active compounds may be formulated as an emulsifiable concentrate (EC), emulsion concentrate (EW), suspension concentrate (SC), soluble liquid (SL), as an oil-based suspension concentrate (OD), and/or suspoemulsions (SE).

In an EC formulation and in an SL formulation, the active compound may be present in dissolved form, whereas in an OD, SC, EW, or SE formulations the active compound may be present as a solid or emulsified liquid.

It is envisaged that the adjuvant of the present invention will particularly find use in EC, EW, SC, SL, OD, or SE formulations.

Agrochemical concentrates are agrochemical compositions, which may be aqueous or non-aqueous, and which are designed to be diluted with water (or a water-based liquid) to form the corresponding spray formulations. Said compositions include those in liquid form (such as solutions, emulsions, or dispersions) and in solid form (especially in water dispersible solid form) such as granules or powders.

Spray formulations are aqueous agrochemical formulations including all the components which it is desired to apply to the plants or their environment. Spray formulations can be made up by simple dilution of concentrates containing desired components (other than water), or by mixing of the individual components, or a combination of diluting a concentrate and adding further individual components or mixtures of components. Typically, such end use mixing is carried out in the tank from which the formulation is sprayed, or alternatively in a holding tank for filling the spray tank. Such mixing and mixtures are typically termed tank mixing and tank mixtures.

The adjuvant may therefore be incorporated into the formulation of the agrochemical active compound (in-can/built-in formulation) or be added after dilution of the concentrated formulation of the spray liquor (tank-mix). To avoid dosage errors and to improve user safety during application of agrochemical products, it is advantageous to incorporate the adjuvant into the formulation. This also avoids the unnecessary use of additional packaging material for the tank-mix products.

According to the needs of the customer, concentrates thus formed may comprise typically up to 95 wt. % agrochemical actives. Said concentrates may be diluted for use resulting in a dilute composition having an agrochemical active concentration of about 0.5 wt. % to about 1 wt. %. In said dilute composition (for example, a spray formulation, where a spray application rate may be from 10 to 500 1.ha-1) the agrochemical active concentration may be in the range from about 0.001 wt. % to about 1 wt. % of the total formulation as sprayed.

The adjuvant of the present invention will typically be used in an amount proportional to the amount of the active agrochemical in the formulation. In agrochemical formulation concentrates, the proportion of the adjuvant will depend on the solubility of the components in the liquid carrier. Typically, the concentration of the adjuvant in such a concentrate will be from 1 wt. % to 99 wt. %. Preferably, from 1 wt. % to 70 wt. %. More preferably, from 3 wt. % to 50 wt. %.

Upon dilution to form, for example, a spray formulation, the adjuvant will typically be present at a concentration of from 0.01 wt. % to 2 wt. %, more usually from 0.03 wt. % to 0.5 wt. % of the spray formulation. Further preferably, from 0.12 wt. % to 0.4 wt. % of the spray formulation.

The ratio of adjuvant to active agrochemical in the agrochemical formulation is preferably from about 1:40 to about 1:1. More preferably, from about 1:20 to about 1:1.

Further preferably, from about 1:5 to 1 about 1:1. This ratio range will generally be maintained for concentrate forms of formulations (e.g. where the adjuvant is included in a dispersible liquid concentrate or dispersible solid granule formulation), and in the spray formulations.

When concentrates (solid or liquid) are used as the source of active agrochemical and/or adjuvant, the concentrates will typically be diluted to form the spray formulations. The dilution may be with from 1 to 10,000, particularly 10 to 1,000, times the total weight of the concentrate of water to form the spray formulation.

Where the agrochemical active is present in the aqueous end use formulation as solid particles, most usually it will be present as particles mainly of active agrochemical. However, if desired, the active agrochemical can be supported on a solid carrier e.g. silica or diatomaceous earth, which can be solid support, filler or diluent material as mentioned above.

The spray formulations will typically have a pH within the range from moderately acidic (e.g., about 3) to moderately alkaline (e.g., about 10), and particular near neutral (e.g., about 5 to 8). More concentrated formulations will have similar degrees of acidity/alkalinity, but as they may be largely non-aqueous, pH is not necessarily an appropriate measure of this.

The agrochemical formulation may include solvents (other than water) such as monopropylene glycol, oils which can be vegetable or mineral oils such as spray oils (oils included in spray formulations as non-surfactant adjuvants), associated with the adjuvant. Such solvents may be included as a solvent for the adjuvant, and/or as a humectant, e.g. especially propylene glycol. When used such solvents will typically be included in an amount of from 5 wt. % to 500 wt. %, desirably 10 wt. % to 100 wt. %, by weight of the adjuvant. Such combinations can also include salts such as ammonium chloride and/or sodium benzoate, and/or urea especially as gel inhibition aids.

In an alternative embodiment the adjuvants of the present invention may be included in a seed coating composition suitable for applying to seeds. Preferably, the adjuvants of the present invention may be included in the seed coating composition.

The adjuvants are suitably present in the seed coating composition at a concentration in the range from 0.5 to 25 wt. %, preferably 2 to 18 wt. %, more preferably 5 to 15 wt. %, in particular 8 to 12 wt. % based on the total weight of the composition.

The coating may include film coating, pelleting, and encrusting or a combination of these techniques as known in the art. It is envisaged that the present invention applies to all said coating types, preferably to film coating.

The seed coating composition of the invention may be applied to the seed in conventional manners.

The seed may be primed or not primed (having been subjected to a treatment to improve the germination rate, e.g. osmopriming, hydropriming, matrix priming).

In one embodiment, the seed is not provided with artificial layers prior to applying the seed coating composition of the invention, for example primer layers comprising a binder, such as a polymer. Accordingly, the seed coating composition is preferably applied directly on the natural outer surface of the seed. Nonetheless, it is possible that the seed surface has undergone a surface treatment prior to applying the seed coating composition.

Preferably, the seed coating composition is applied as a liquid composition and/or emulsion and/or dispersion and/or latex composition and thereafter solidified (including cured and/or dried) to form a seed coating. The term “liquid coating composition” as used in this application is meant to include coating compositions in the form of a suspension, emulsion, and/or dispersion, preferably a dispersion.

Conventional means of coating may be employed for coating the seeds. Various coating machines are available to the person skilled in the art. Some well known techniques include the use of drum coaters, fluidised bed techniques, rotary coaters (with and without integrated drying), and spouted beds. Suitably, the seed coating composition is applied to the seed by a rotary coater, a rotary dry coater, a pan coater, or a continuous treater.

The seed coating composition can, for instance, be applied by film coating, spraying, dipping, or brushing of the seed coating composition. Preferably, the method comprises applying the seed coating composition to form a film or seed coating layer.

Seed coating typically involves forming on the surface of the seeds a firmly adhering, moisture permeable coating. The process typically comprises applying a liquid seed coating composition to the seeds before planting.

An additional film coat layer may optionally be applied over the top of the coating layer of the invention to provide additional benefits, including but not limited to cosmetics, coverage, actives, nutrients, and processing improvements such as faster drying, seed flow, durability, and the like.

The agrochemical formulation or seed coating composition may also include other components as desired. These other components may be selected from those including:
“binders, particularly binders which are readily water soluble to give low viscosity solutions at high binder concentrations, such as polyvinylpyrrolidone; polyvinyl alcohol; carboxymethyl cellulose; gum arabic; sugars e.g., sucrose or sorbitol; starch; ethylene-vinyl acetate copolymers, sucrose, and alginates,” diluents, absorbents, or carriers such as carbon black; talc; diatomaceous earth; kaolin; aluminium, calcium, or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
” antifoam agents, e.g., polysiloxane antifoam agents, typically in amounts of 0.005 wt. % to 10 wt. % of the formulation;
“viscosity modifiers such as commercially available water soluble or miscible gums, e.g., xanthan gums, and/or cellulosics, e.g., carboxy-methyl, ethyl or propylcellulose; and/or” preservatives and/or anti-microbials such as organic acids, or their esters or salts such as ascorbic e.g. ascorbyl palmitate, sorbic e.g. potassium sorbate, benzoic e.g., benzoic acid and methyl and propyl 4-hydroxybenzoate, propionic e.g., sodium propionate, phenol e.g., sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The agrochemical formulation or seed coating composition according to the present invention may also contain components, such as surfactant materials which form part of the emulsifier system. Said surfactants may include surfactant dispersants.

Other adjuvants not within the scope of the present invention, such as surfactant adjuvants, may be included in the compositions and formulations of and used in this invention. Examples include alkylpolysaccharides (more properly called alkyl oligosaccharides); fatty amine ethoxylates e.g. coconut alkyl amine 2EO; and derivatives of alk (en) yl succinic anhydride, in particular those described in PCT applications WO 94/00508 and WO 96/16930.

The formulation/composition may comprise one or more biologically active ingredients (including plant enhancing agents, in particular plant protective products (also referred to as PPPs)). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides. Further possible active ingredients include disinfectants, microorganisms, rodent killers, weed killers (herbicides), attracting agents, (bird) repellent agents, plant growth regulators (such as gibberellic acid, auxin or cytokinin), nutrients (such a potassium nitrate, magnesium sulphate, iron chelate), plant hormones, minerals, plant extracts, germination stimulants, pheromones, biological preparations, etc.

Suitable agrochemical actives for use in the formulations or seed coating composition according to the invention are all agrochemically active compounds that may be solid or liquid at room temperature. It is envisaged that the adjuvant of the present invention would have broad applicability to all types of agrochemical actives.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so-called plant growth regulators.

Biocides for use in agrochemical formulations or seed coating compositions of the present invention are typically divided into two sub-groups: “pesticides, including fungicides, herbicides, insecticides, algicides, molluscicides, miticides and rodenticides, and antimicrobials, including germicides, antibiotics, antibacterials, antivirals, antifungals, antiprotozoals and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest. A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when it comes into contact with the fungicide retained on leaf surfaces. A systemic fungicide is absorbed into plant tissues and kills the fungus when it attempts to invade the host.

Examples for suitable fungicides, according to the present invention, encompass the following species: (3-ethoxypropyl) mercury bromide, 2-methoxyethylmercury chloride, 2-phenylphenol, 8-hydroxyquinoline sulphate, 8-phenylmercuri oxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulphide, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulphide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper (II) acetate, copper (II) carbonate, basic, copper fungicides, copper hydroxide, copper naphthenate, copper oleate, copper oxychloride, copper (II) sulphate, copper sulphate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulphon, dinoterbon, diphenylamine, dipyrithione, disulphiram, ditalimfos, dithianon, dithiocarbamate fungicides, DNOC, dodemorph, dodicin, dodine, donatodine, drazoxolon, edifenphos, epoxiconazole, etaconazole,etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulph, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, fluopicolide, fluoroimide, fluotrimazole, fluoxastrobin, fluquinconazole, flusilazole, flusulphamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulphocarb, methfuroxam, methyl bromide, methyl isothiocyanate, methylmercury benzoate, methylmercury dicyandiamide, methylmercury pentachlorophenoxide, metiram, metominostrobin, metrafenone, metsulphovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulphamide fungicides, phosdiphen, phthalide, phthalimide fungicides, picoxystrobin, piperalin, polycarbamate, polymeric dithiocarbamate fungicides, polyoxins, polyoxorim, polysulphide fungicides, potassium azide, potassium polysulphide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfiir, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulphide, spiroxamine, streptomycin, strobilurin fungicides, sulphonanilide fungicides, sulphur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide, and mixtures thereof.

A herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Suitable herbicides may be selected from the group comprising: aryloxycarboxylic acid e.g., MCPA, aryloxyphenoxypropionates e.g. clodinafop, cyclohexanedione oximes e.g., sethoxydim, hydroxybenzonitriles e.g., bromoxynil, sulphonylureas e.g., nicosulphuron, triazolopyrimidines e.g., penoxsulam, triketiones e.g., mesotriones, triazine herbicides such as metribuzin, hexaxinone, or atrazine; sulphonylurea herbicides such as chlorsulfuron; uracils such as lenacil, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxyacetic acids; diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; and/or dihalobenzonitrile herbicides such as bromoxynil, or ioxynil, benzoic acid herbicides, dipyridilium herbicides such as paraquat; and other herbicides such as clomazone, carfentrazone, saflufenacil, and pyroxasulphone.

Particularly preferred herbicides may be selected from 2,4-dichlorophenoxyacetic acid (2,4-D), atrazine, dicamba as benzoic acid, glyphosate, glufosinate, imazapic as imidazolinone, metolachlor as chloroacetamide, picloram, clopyralid, and triclopyr as pyridinecarboxylic acids or synthetic auxins, their respective water soluble salts and esters, and mixtures thereof.

An insecticide is a pesticide used against insects in all developmental forms, and include ovicides and larvicides used against the eggs and larvae of insects. Insecticides are used in agriculture, medicine, industry, and the household.

Suitable insecticides may include those selected from: chlorinated insecticides such as, for example, Camphechlor, DDT, Hexachloro-cyclohexane, gamma-Hexachlorocyclohexane, Methoxychlor, Pentachlorophenol, TDE, Aldrin, Chlordane, Chlordecone, Dieldrin, Endosulphan, Endrin, Heptachlor, Mirex and their mixtures; organophosphorous compounds such as, for example, Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulphoton, Ethoprop, Fenamiphos, Fenitrothion, Fenthion, Fosthiazate, Malathion, Methamidophos, Methidathion, Methyl-parathion, Mevinphos, Naled, Omethoate, Oxydemeton-methyl, Parathion, Phorate, Phosalone, Phosmet, Phostebupirim, Pirimiphos-methyl, Profenofos, Terbufos, Tetrachlorvinphos,

Tribufos, Trichlorfon and their mixture; carbamates such as, for example, Aldicarb, Carbofuran, Carbaryl, Methomyl, 2-(1-Methylpropyl) phenyl methylcarbamate and their mixtures; pyrethroids such as, for example, Allethrin, Bifenthrin, Deltamethrin, Permethrin, Resmethrin, Sumithrin, Tetramethrin, Tralomethrin, Transfluthrin and their mixtures; plant toxin derived compounds such as, for example, Derris (rotenone), Pyrethrum, Neem (Azadirachtin), Nicotine, Caffeine and their mixture; neonicotinoids such as imidacloprid; abamectin e.g., emamactin; oxadiazines such as indoxacarb; and/or anthranilic diamides such as rynaxypyr.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such as moths, slugs, and snails. These substances include metaldehyde, methiocarb and aluminium sulphate. A nematicide is a type of chemical pesticide used to kill parasitic nematodes (a phylum of worm).

Most preferably, the active present in the agrochemical formulation or seed coating composition of the present invention is selected from triazole fungicides, strobilurin fungicides, or a combination thereof. In particular, tebuconazole, flutriafol, carbendazim, azoxystrobin, kresoxim-methyl, cyproconazole, or pyraclostrobin.

Nutrients may be present in addition to, or as an alternative to, agrochemical actives. In such formulations/compositions the nutrient is typically in a dry form.

The nutrients may preferably be a solid phase nutrients. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the concentrate after addition.

Nutrients refer to chemical elements and compounds which are desired or necessary to promote or improve plant growth. Suitable nutrients generally are described as macronutrients or micronutrients. Suitable nutrients for use in the concentrates according to the invention are all nutrient compounds.

Micronutrients typically refer to trace metals or trace elements, and are often applied in lower doses. Suitable micronutrients include trace elements selected from zinc, boron, chlorine, copper, iron, molybdenum, and manganese. The micronutrients may be in a soluble form or included as insoluble solids, and may be salts or chelated.

Macronutrients typically refer to those comprising nitrogen, phosphorus, and potassium, and include fertilisers such as ammonium sulphate, and water conditioning agents. Suitable macro nutrients include fertilisers and other nitrogen, phosphorus, potassium, calcium, magnesium, sulphur containing compounds, and water conditioning agents.

Suitable fertilisers include inorganic fertilisers that provide nutrients such as nitrogen, phosphorus, potassium, or sulphur. Fertilisers may be included in diluted formulations at relatively low concentrations or as more concentrated solutions, which at very high levels may include solid fertiliser as well as solution.

It is envisaged that inclusion of the nutrient would be dependent upon the specific nutrient, and that micronutrients would typically be included at lower concentrations whilst macronutrients would typically be included at higher concentrations.

Biostimulant component may be added to the formulation or seed coating composition to promote growth of a crop plant. The biostimulant component may comprise or consist of one or more biostimulants.

Examples of useful biostimulants include, but are not limited to, plant growth hormones and plant growth regulators, such as cytokinins, auxins, gibberellins, ethylene, abscisic acid. Other biostimulants include, protein hydrolysate derivatives, seaweed extracts, amino acids, botanical extracts, chitosan derivatives, biopolymers, inorganic compounds, humic substances, microbial inoculants and microbial products, or mixtures thereof.

The adjuvant of the present invention will provide adjuvancy to the agrochemical formulation in which it is comprised, and particular may find application providing fungicide adjuvancy.

As used herein, the term ‘adjuvant’ or ‘adjuvancy’ refers to compounds which when added to an agrochemical formulation will improve the agrochemical's desired effect. The adjuvant may affect the diluent, the mixture, the active, or the target by its improvements of the active's performance. An adjuvant can be used to adhere the pesticide on the area where the pesticide is functional, change the epidermal layer of the leaf surface permitting pesticide entry, and/or sensitise the target pest to the active pesticide in an agrochemical formulation.

Specific adjuvancy effects may include surfactants, emulsifiers (dispersants and suspending agents), oils, emulsifiable oils, compatibility agents, buffering and conditioning agents, defoaming agents, deposition agents, drift control agents, thickeners, spreaders (wetters), stickers (builders and extenders), plant penetrants, translocators, soil penetrants, stabilising agents (UV filters), and/or pest sensitisation to the active pesticide.

Preferably, the adjuvants of the present invention may find use as either the sole component or principal functioning agent in adjuvants formulated either for tank-added use, or formulated directly into pesticide concentrates.

As a measure of the adjuvant activity in relation to the activity of the fungicide alone (e.g., pyraclostrobin) to B. cinerea a value of percent inhibition (adjuvant and fungicide) divided by percent inhibition (fungicide) can be defined, with higher values desired.

A value of 1 would therefore represent equal activity of the adjuvant/fungicide combination to the fungicide alone, whereas a value above 1 would represent higher activity with the adjuvant/fungicide combination than the fungicide alone.

The actives of the present invention may have a value greater than 1. Preferably greater than 1.2, most preferably greater than 1.4.

All of the features described herein may be combined with any of the above aspects, in any combination.

### EXAMPLES

In order that the present invention may be more readily understood, reference will now be made, by way of example, to the following description.

It will be understood that all tests and physical properties listed have been determined at atmospheric pressure and room temperature (i.e., 20-25° C.), unless otherwise stated herein, or unless otherwise stated in the referenced test methods and procedures.

### Formation

To synthesize cyclo (-Phe-Pip) diketopiperazine (If), pipecolic acid (201.7 mg, 1.5617 mmol) and phenyl alanine methyl ester (3.33 g, 15.4 mmol) were dissolved in dimethylformamide (20 mL) and cooled to 0° C. in an ice bath before adding benzotriazol-1-yloxytripyrrolidinophosphonium hexafluorophosphate (PyBOP, 1.905 g, 3.661 mmol) and triethylamine (0.5 mL, 3.587 mmol). The reaction solution was allowed to warm to room temperature and stir overnight.

The reaction was concentrated in vacuo to yield the crude product, which was fractionated by normal-phase chromatography (silica, hexanes->ethyl acetate) using a CombiFlash NextGen system (Teledyne Isco). Fractions containing the dipeptide product (380.0 mg, 1.3087 mmol, 83.8% yield) were combined and evaporated in vacuo before proceeding to the next step.

The dipeptide was dissolved in methanol (75 mL) followed by the addition of triethylamine (1 mL). The reaction was heated to 60° C. in an oil bath for 3 days before concentrating it in vacuo. The reaction product was purified by normal-phase chromatography (silica, hexanes->ethyl acetate) using a CombiFlash NextGen system (Teledyne Isco). Fractions containing the cyclo (-Phe-Pip) diketopiperazine product (75.5 mg, 0.2923 mmol, 22% yield) were combined and evaporated in vacuo.

To synthesize cyclo (-Phe-dhPro) diketopiperazine (Ig), Boc-3,4-dehydro-L-proline (257.4 mg, 1.207 mmol), phenylalanine methyl ester (390.4 mg, 1.810 mmol) and N-hydroxysuccinimide (205.0 mg, 1.781 mmol) were dissolved in anhydrous CH₂Cl₂ (10 mL). The mixture was cooled to 0° C. in an ice bath before adding diisopropylcarbodiimide (0.273 mL, 1.763 mmol) and triethylamine (0.245 mL, 1.758 mmol).

The reaction was allowed to warm to room temperature and stir overnight before partitioning between ethyl acetate and water. The organic phase was recovered and evaporated in vacuo to yield the crude product, which was fractionated by normal-phase chromatography (silica, hexanes->ethyl acetate) using a CombiFlash NextGen system (Teledyne Isco).

Fractions containing the dipeptide product (323.1 mg, 0.8629 mmol, 71% yield) were combined and evaporated in vacuo before proceeding to the next step. The dipeptide underwent a Boc-deprotection by dissolving it in dichloromethane (6 mL) before adding trifluoroacetic acid (6 mL). The reaction was stirred at room temperature overnight before concentrating it in vacuo.

The crude product was used in the next step without further purification or characterisation. The deprotected dipeptide was dissolved in methanol (75 mL) followed by the addition of triethylamine (1 mL). The reaction was heated to 60° C. in an oil bath for 3 days before concentrating it in vacuo.

The reaction product was purified by normal-phase chromatography (silica, hexanes->ethyl acetate) using a CombiFlash NextGen system (Teledyne Isco). Fractions containing the cyclo (-Phe-Pip) diketopiperazine product (65.2 mg, 0.2691 mmol, 31% yield over two steps) were combined and evaporated in vacuo.

The structures of the diketopiperazines were elucidated by combined mass spectrometry and NMR analysis. NMR spectra were recorded on a Bruker Avance III 400 MHZ NMR spectrometer operating at 400 and 150 MHz for ¹H and ¹³C, respectively. Spectra were referenced to the residual solvent signal.

NMR analysis of the metabolites matched with literature data and confirmed the structures as diketopiperazines (Ia, Ib, Ic, Id, Ie, If, & Ig).

### Adjuvancy Parameters

The parameters ‘percent inhibition’ and ‘fold change’ will be understood to represent ad be calculated as follows:

Percent Inhibition-The percent inhibition will be understood to represent the amount the fungicide and/or adjuvant that inhibits the visible growth of the microorganism after 48 hours incubation at 22° C. relative to vehicle treated controls. This is calculated using the following formula:

$$[ ( {∅}_{C} - {∅}_{T} ) / {∅}_{C} ] \times 100 \%$$

where:

Ø_{C}=diameter of the colony grown on agar supplemented with vehicle (i.e. vehicle treated control), and

Ø_{T}=diameter of the colony grown on agar supplemented with fungicide and/or adjuvant formulated in an appropriate vehicle (i.e., solvent such as water C₂H₅OH, CH₃OH, CH₃CN, DMSO).

Fold Change—The fold change is a measure of the adjuvant/fungicide combination in inhibiting a microorganism compared to the fungicide alone. This indicates how the adjuvant performs relative to the fungicide alone. This is calculated using the following formula:

INH_{AF}/INH_{F}

where:
INH_{AF}=percent inhibition of fungal growth when treated with fungicide and adjuvant, and
INH_{F}=percent inhibition of fungal growth when treated with fungicide alone.

Adjuvancy Results

Botrytis cinerea (ATCC 90479) was cultured on Difco Potato Dextrose Agar (PDA) for 7 days with diurnal UV cycles (12 h UV light and 12 h dark). Spores were harvested in a buffered, sterile saline solution (w/v: 0.9% NaCl with 1% Tween 80) and counted using a haemocytometer. The spore suspension was adjusted to a final concentration of 8.5x106 spores/mL to create a standardised inoculum.

To prepare hyphal fragments for adjuvant testing, 8.5x104 spores were used to inoculate 10 mL of Difco Potato Dextrose Broth in a 150×25 mm tube. The tube was incubated at 220 RPM, 22° C. for 48 hours.

To create hyphal fragments from the culture, the culture was transferred to a 50 mL plastic conical tube containing approximately 20 sterile 5 mm diameter glass beads and vortexed for 5 min. After vortexing the tube was allowed to stand for 5 min to allow large mycelial clumps to settle and then the top layer containing hyphal fragments was removed and used as inocula for growth inhibition assays.

Fungicides and adjuvants were dissolved in methanol and added to molten PDA (˜50° C.) and then the agar was distributed in the wells of 12 well multiwell plates (1 mL/well). The plates were cooled to room temperature and 10 μL of hyphal inoculum was added to the centre of each well. The plates were incubated at 22° C. for 48 hours and then the colony diameter was measured using a digital caliper. The biological growth control consisted of hyphae and vehicle (0.07% methanol), the negative control was media and vehicle (0.07% methanol).

The results of the adjuvant actives of the invention are shown in Table 1. Adjuvant activity with pyraclostrobin against B. cinerea was observed for each of the compounds tested, most notably diketopiperazine Ie and diketopiperazine Ic which showed a 1.56 and 1.52 fold increase in fungicidal activity compared to pyraclostrobin alone at 0.06 μg/mL.

Diketopiperazine (Ia, Ib, Ic, Id, Ie, If & Ig), did not demonstrate any inherent fungicidal activity on their own at any of the concentrations tested.

TABLE 1
Effect of adjuvants on fungicidal
activity of pyraclostrobin (Pyra).

| | | Fold Change | |
|---|---|---|---|
| | Adjuvant | in Growth Inhibition | |
| | Concentration | Pyra | Pyra |
| Adjuvant | (μg/mL) | 0.0625 μg/mL | 0.0313 μg/mL |
| None | 0 | 1.00 | 1.00 |
| DKP (Ia) | 50 | 1.15 | 1.32 |
| DKP (Ib) | 50 | 1.45 | 1.14 |
| DKP (Ic) | 50 | 1.52 | 1.23 |
| DKP (Id) | 50 | 1.35 | 1.09 |
| DKP (Ie) | 50 | 1.56 | 0.96 |
| DKP (If) | 64 | 1.28 | 1.34 |
| DKP (Ig) | 64 | 1.27 | 1.22 |

The effect of the adjuvants on fungicidal activity is represented as fold increase in growth inhibition. A value of 1 indicates no increase in fungicidal activity. A value less than 1 indicates reduced fungicidal activity and a value greater than 1 indicates increased fungicidal activity.

It can be seen in Table 1 that the adjuvants clearly provide adjuvancy properties to the active at different active concentrations.

It is to be understood that the invention is not to be limited to the details of the above embodiments, which are described by way of example only. Many variations are possible.

1. An agrochemical formulation comprising:
i) an adjuvant selected from diketopiperazine according to formula (I) 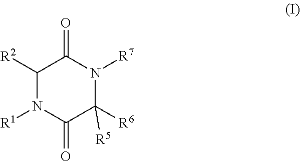
wherein:
R¹ represents hydrogen or C₁ to C₄ alkyl;
R² represents hydrogen, C₁ to C₄ alkyl, or —CH (R³) (R⁴);
R³ and R⁴ each independently represents hydrogen, C₁ to C₃ alkyl, phenyl, or substituted phenyl;
R⁵ represents hydrogen, C₁ to C₄ alkyl, hydroxyl, methoxy, or ethoxy;
R⁶ and R⁷ each independently represents hydrogen, C₁ to C₄ alkyl, hydroxyl, methoxy, ethoxy, or R⁶ and R⁷ together represent a straight chain C₃ or C₄ linking group, which with the respectively bonded N and C atoms forms a 5 or 6 membered optionally substituted saturated or unsaturated ring; and
ii) at least one agrochemical active, nutrient, or biostimulant.

2. The formulation according to claim 1, wherein:
R¹ represents hydrogen, methyl, or ethyl;
R² represents hydrogen, or —CH (R³) (R⁴);
at least one of R³ and R⁴ represents phenyl, whilst the other represents hydrogen, methyl, or ethyl;
R⁵ represents hydrogen or methyl;
R⁶ and R⁷ each independently represents hydrogen or C₁ to C₄ alkyl, or R⁶ and R⁷ together represent a straight chain C₃ or C₄ linking group, which with the respectively bonded N and C atoms forms a 5 or 6 membered optionally substituted saturated or unsaturated ring.

3. The formulation according to claim 1, wherein:
R¹ represents hydrogen or methyl;
R² represents hydrogen, or —CH (R³) (R⁴);
at least one of R³ and R⁴ represents phenyl, whilst the other represents hydrogen or methyl;
R⁵ represents hydrogen;
R⁶ and R⁷ each independently represents hydrogen or methyl, or R⁶ and R⁷ together represent a straight chain C₃ or C₄ linking group selected from n-propyl, n-butyl, or n-propenyl.

4. The formulation according to claim 1, wherein the adjuvant is selected from diketopiperazines of the following formulas:

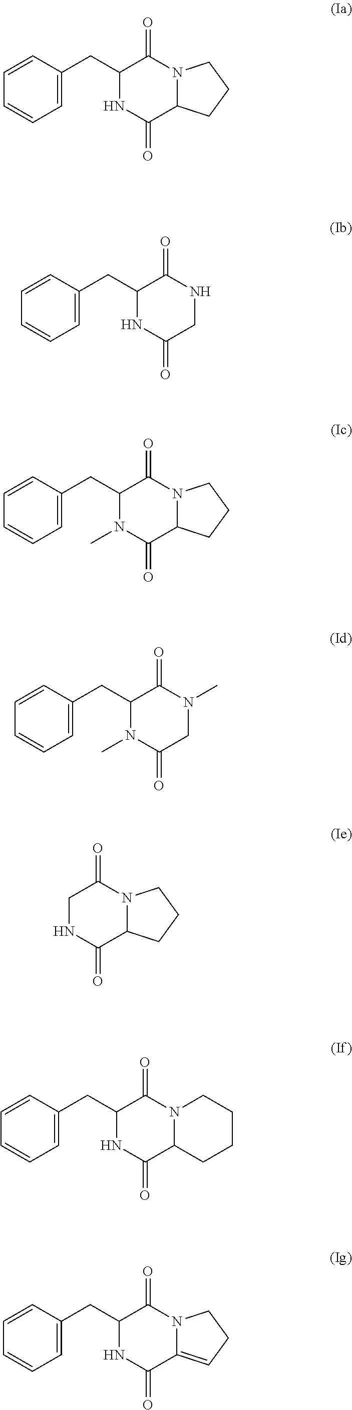

5. A concentrate formulation suitable for making an agrochemical formulation of claim 1, the concentrate comprising:
i) an adjuvant selected from diketopiperazine according to formula (I) 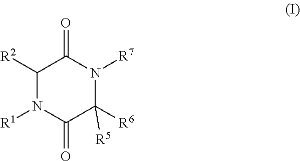
wherein:
R¹ represents hydrogen or C₁ to C₄ alkyl;
R² represents hydrogen, C₁ to C₄ alkyl, or —CH (R³) (R⁴);
R³ and R⁴ each independently represents hydrogen, C₁ to C₃ alkyl, phenyl, or substituted phenyl;
R⁵ represents hydrogen, C₁ to C₄ alkyl, hydroxyl, methoxy, or ethoxy;
R⁶ and R⁷ each independently represents hydrogen, C₁ to C₄ alkyl, hydroxyl, methoxy, ethoxy, or R⁶ and R⁷ together represent a straight chain C₃ to C₄ linking group, which with the respectively bonded N and C atoms forms a 5 or 6 membered optionally substituted saturated or unsaturated ring; and
ii) at least one agrochemical active, nutrient, or biostimulant.

6. The concentrate formulation according to claim 5, wherein the concentrate is a emulsifiable concentrate (EC), emulsion concentrate (EW), suspension concentrate (SC), soluble liquid (SL), as an oil-based suspension concentrate (OD), or a suspoemulsion (SE).

7. Use of compound selected from diketopiperazine according to formula (I) 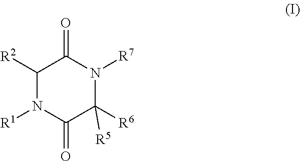
wherein:
R¹ represents hydrogen or C₁ to C₄ alkyl;
R² represents hydrogen, C₁ to C₄ alkyl, or —CH (R³) (R⁴);
R³ and R⁴ each independently represents hydrogen, C₁ to C₃ alkyl, phenyl, or substituted phenyl;
R⁵ represents hydrogen, C₁ to C₄ alkyl, hydroxyl, methoxy, or ethoxy;
R⁶ and R⁷ each independently represents hydrogen, C₁ to C₄ alkyl, hydroxyl, methoxy, ethoxy, or R⁶ and R⁷ together represent a straight chain C₃ to C₄ linking group, which with the respectively bonded N and C atoms forms a 5 or 6 membered optionally substituted saturated or unsaturated ring;
as an adjuvant in an agrochemical formulation comprising at least one agrochemical active, nutrient, or biostimulant.

8. A method of treating vegetation to control pests, the method comprising applying a formulation in accordance with claim 1, either to the vegetation or to the immediate environment of the vegetation.

9. A seed coating composition comprising diketopiperazine adjuvants according to claim 1.

10. A method of treating vegetation to control pests, the method comprising applying a diluted concentrate formulation in accordance with claim 5, either to the vegetation or to the immediate environment of the vegetation.
